(19) United States
(12) Patent Application Publication
(10) Pub. No.: US 2013/0243439 A1
(43) Pub. Date: Sep. 19, 2013

(54) OPTICAL TRANSCEIVER, METHOD FOR CONTROLLING THE OPTICAL TRANSCEIVER AND NON-TRANSITORY COMPUTER READABLE MEDIUM EMBODYING INSTRUCTIONS FOR CONTROLLING A DEVICE

(71) Applicant: Yota ITO, Tokyo (JP)

(72) Inventor: Yota ITO, Tokyo (JP)

(21) Appl. No.: 13/796,475

(22) Filed: Mar. 12, 2013

(30) Foreign Application Priority Data
Mar. 13, 2012 (JP) 2012-055971

(51) Int. Cl. H04B 10/40

(52) U.S. Cl. CPC H04B 10/40
USPC 398/135

(57) ABSTRACT

An optical transceiver includes a transmitter that transmits an optical signal, and a receiver that receives a reference signal. The receiver receives the optical signal transmitted by its own transmitter. A controller performs an adjustment of the optical signal, transmitted by the transmitter, based on the reference signal.

### BACKGROUND

This document relates to an optical transceiver, and more particularly, to the adjustment of transmitter signals.

### RELATED ART

Patent Literature 1 discloses an optical communication method and an optical transceiver. In the optical communication method according to Patent Literature 1, the optical transceiver acquires information about the transmission rate and data format of a baseband signal from an external interface. The optical transceiver also transmits to and receives from another optical transceiver a test signal at a transmission rate and in a transmission format that is set based on the information from the external interface. In addition, the optical transceiver sets a transmission rate and transmission format by comparing the transmission rate, set to transmit the test signal, with the transmission rate of the received test signal, and then transmits and receives information about data formats so as to select a data format. According to Patent Literature 1, this approach is said to allow the optical transceiver to be compatible with signals at various transmission rates, in various data formats and transmission formats, with a simple assembly including a single physical interface.

Patent Literature 1, in particular, is Japanese Unexamined Patent Application Publication No. 2005-229298. Optical transceivers, such as an SFP (small form-factor pluggable) and an XFP (10 gigabit small form-factor pluggable), have a region for storing values, adjusted to impart desired characteristics to the optical transceivers, in a storage area in addition to a memory map, in conformity with a MSA (multi source agreement).

The firmware of such optical transceivers has not only a normal mode of regulating the operation in normal usage, but also an adjustment mode of regulating the operation so as to adjust the optical transceivers. In general, access from external components to the region storing the adjusted value for the optical transceiver is disabled in the normal mode, but is enabled in the adjustment mode.

FIG. 10 illustrates a general configuration when adjustment processing is performed. The characteristics, including the waveform, of a transmitter signal from an optical transceiver 101, are measured by an external measurement apparatus 102 including a power meter 111, optical waveform measuring device 112, and so on. An adjustment program 121 in a personal computer 103 determines an adjusted value of the transmitter signal based on the characteristic information of the transmitter signal obtained from the external measurement apparatus 102, and makes access to firmware 131 of the optical transceiver 101 via an I2C communication to store the adjusted value into an adjustment memory map 132. The firmware 131 of the optical transceiver 101 adjusts the waveform of the transmitter signal based on the adjusted value stored in the adjustment memory map 132. This series of actions is repeatedly performed until a transmitter signal, with a desired waveform, is obtained.

In factories that manufacture the optical transceivers, adjustment, test and other processes are performed to impart the desired characteristics to the optical transceivers. The adjustment, test, and the other processes are generally performed automatically by a program through communication between the optical transceiver and the measurement apparatuses.

Such factories can prepare the aforementioned testing program suitable for the factory-owned measurement apparatuses because the test is conducted in conformity with the MSA (multi source agreement). Even if the factories are EMS (Electronics Manufacturing Service) providers, a common testing program can be shared in many cases irrespective of the design of transceivers of the commissioning parties.

However, in the case of the adjustment program in which the address of an adjusted-value storing region, the range of adjusted values, and other factors vary by the design of the transceiver of the commissioning party, a new adjustment program often has to be prepared for each design. In addition, if the commissioned party of the EMS is changed to another, the program needs to be modified in accordance with the measurement apparatus owned by the new commissioned party.

### SUMMARY

To solve the problems, the exemplary embodiments provide a widely usable adjustment program under varying measurement environments. However, the exemplary embodiments may achieve objectives other than those described above. Further, exemplary embodiments are not required to achieve the objectives described above, and an exemplary embodiment may not achieve any of the objectives described above.

A first aspect of the exemplary embodiment is directed to an optical transceiver including a transmission unit, a reception unit, and a control unit. The control unit, operated by firmware provided in the optical transceiver, performs adjustment processing of adjusting a transmitter signal, transmitted by the transmission unit, based on a reference signal. In the adjustment processing, the control unit acquires the reference signal via reference-signal output unit and the reception unit, and acquires the transmitter signal by a connection of the transmission unit to the reception unit.

A second aspect of the exemplary embodiment is directed to a method for adjusting a transmitter signal of an optical transceiver. The method includes a step of performing adjustment processing, of adjusting a transmitter signal based on a reference signal, by firmware provided in the optical transceiver, a step of acquiring the reference signal from a source that outputs the reference signal and a receiver that receives it, in the adjustment processing, and a step of acquiring the transmitter signal by connecting the output of the transmitter signal and the input to the receiver, in the adjustment processing.

A third aspect of the exemplary embodiment is directed to an adjustment program for adjusting a transmitter signal of an optical transceiver. The adjustment program requests a computer that controls the optical transceiver to perform adjustment processing of adjusting the transmitter signal based on a reference signal, processing of acquiring the reference signal by operationally connecting a source that outputs the reference signal and a receiver in the adjustment processing, and processing of acquiring the transmitter signal by connecting the output of the transmitter signal to the receiver in the adjustment process.

Thus, the adjustment of transmitter signals can be carried out without resort to an external system, such as an external measurement apparatus, and without depending on a personal computer for adjustment. This makes it possible to use an adjustment program without substantial change even when the measurement environment is changed.

### BRIEF DESCRIPTION OF THE DRAWINGS

FIG. 1 illustrates a functional configuration of an optical transceiver according to the first exemplary embodiment.

FIG. 2 illustrates by an example a configuration of hardware of the optical transceiver according to the first exemplary embodiment.

FIG. 3 is a flow chart showing processing steps for adjusting the transmitter signal by the firmware according to the first exemplary embodiment.

FIG. 4 illustrates connection between the optical transceiver and an external system in a state of waiting for a reference signal.

FIG. 5 illustrates connection between the optical transceiver and the external system in a state of waiting for a transmitter signal.

FIG. 6 illustrates by an example a configuration of hardware of an optical transceiver according to the second embodiment.

FIG. 7 illustrates by an example a configuration of hardware of an optical transceiver according to the third embodiment.

FIG. 8 illustrates by an example a configuration of hardware of an optical transceiver according to the fourth embodiment.

FIG. 9 illustrates connection between the optical transceiver and an external system in a state of waiting for a reference signal according to the fifth embodiment.

FIG. 10 illustrates by an example a general configuration of an optical transceiver that adjusts transmitter signals.

### DETAILED DESCRIPTION

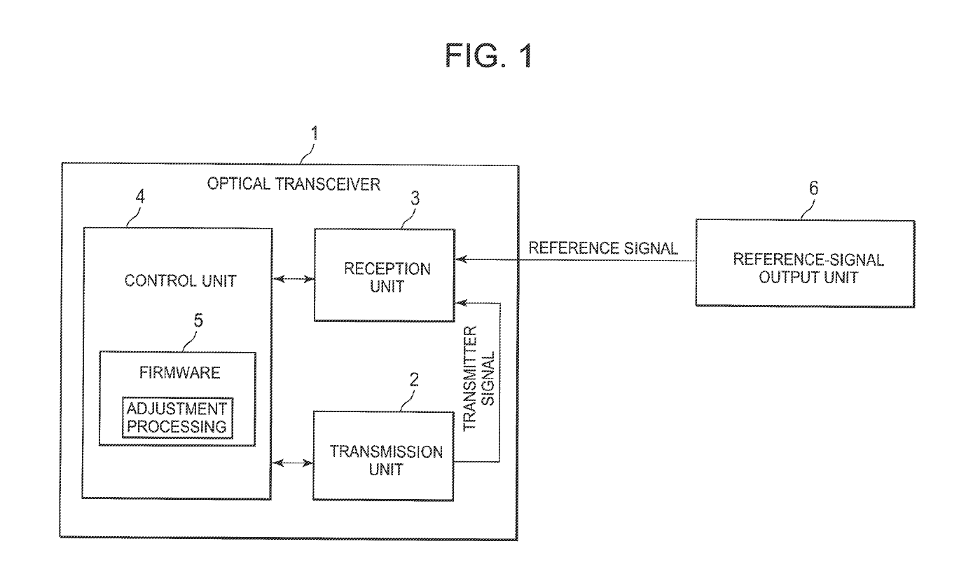

With reference to the drawings, exemplary embodiments will be described. FIG. 1 illustrates a functional configuration of an optical transceiver 1 according to the first exemplary embodiment. The optical transceiver 1 includes a transmission unit 2, a reception unit 3, and a control unit 4. The word “exemplary” is used herein to mean “serving as an example, instance, or illustration”. Any embodiment described herein as “exemplary” is not necessarily to be construed as preferred or advantageous over other embodiments.

The transmission unit 2 outputs transmitter signals used, normally, for communication to other optical transceivers or other components (FIG. 1 does not illustrate such a mode). The reception unit 3 inputs receiver signals from the other optical transceivers or the other components.

The control unit 4 is controlled by firmware 5 to control not only the transmission unit 2, reception unit 3, and regular communication processing, but also adjustment processing to adjust the transmitter signals based on a reference signal. That is to say, the control unit 4 controls whether the optical transceiver 1 is operated in a normal mode for communication with other optical transceivers, or whether it is operated in an adjustment processing mode in, e.g., a factory in which an adjustment processing is carried out prior to shipping.

To execute the adjustment processing, the control unit 4 connects a reference-signal output unit 6, which supplies reference signals, and the reception unit 3 to obtain the characteristics of a reference signal, and connects the transmission unit 2 and reception unit 3 to obtain the characteristics of a transmitter signal. In addition, the control unit 4 performs the adjustment processing, under control of the firmware 5, based on the characteristics of the reference signal and the transmitter signal obtained via the reception unit 3.

The above-described configuration can make the program for adjustment processing widely usable even if the measurement environment changed.

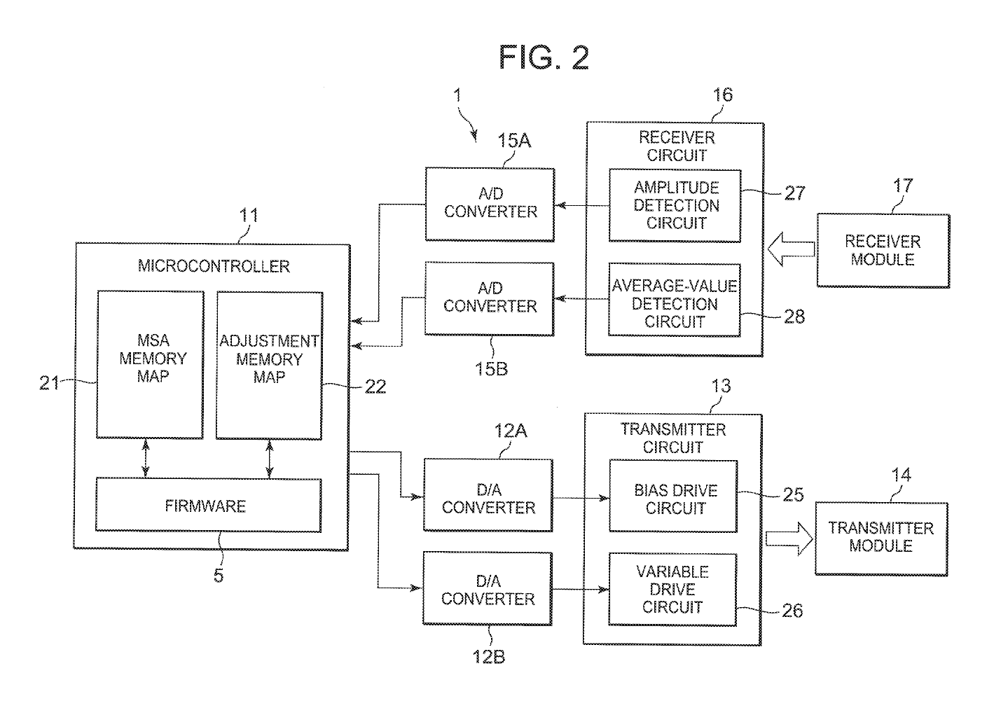

FIG. 2 illustrates the hardware configuration of the optical transceiver 1 according to the present embodiment. The optical transceiver 1 includes a microcontroller 11, D/A converters 12A, 12B, a transmitter circuit 13, a transmitter module 14, A/D converters 15A, 15B, a receiver circuit 16, and a receiver module 17. The microcontroller is an information processing unit composed of a CPU controlling the whole optical transceiver 1, memory and other components. The memory stores firmware 5, an MSA memory map 21, an adjustment memory map 22, and so on. The transmitter circuit 13 includes a bias drive circuit 25 and a variable drive circuit 26, while the receiver circuit 16 includes an amplitude detection circuit 27 and an average-value detection circuit 28.

An optical signal received by the optical receiver module 17 is converted into an electrical signal and input to the receiver circuit 16. The electrical signal having entered the receiver circuit 16 is analyzed by the amplitude detection circuit 27 and average-value detection circuit 28 that detect the characteristics, such as an output amplitude and optical output power, of the signal. These characteristics are represented by analog signals that are in turn converted by the A/D converters 15A, 15B, respectively, into digital signals and input to the microcontroller 11. Thus, the firmware 5 mounted in the microcontroller 11 acquires the characteristics, such as waveforms, of the optical signal, which is input to the receiver module 17, in the form of a digital signal.

The firmware 5 outputs digital control signals for driving the transmitter module 14 to the D/A converters 12A, 12B. The bias drive circuit 25 and variable drive circuit 26 of the transmitter circuit 13 drives the transmitter module 14 in response to the analogue control signals input from the D/A converters 12A, 12B, respectively. The transmitter module 14 outputs a transmitter signal having a waveform adjusted by the microcontroller 11.

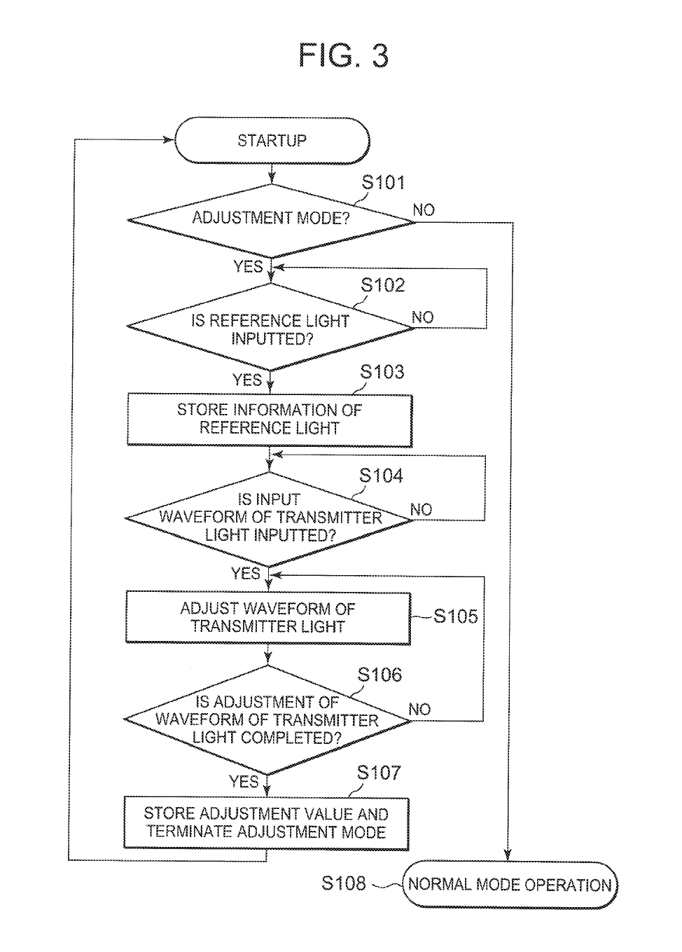

FIG. 3 shows processing steps to adjust transmitter signals by the firmware 5. When power is turned on to activate the optical transceiver 1, the firmware 5 starts operation mode determination to determine whether the optical transceiver 1 is in an adjustment mode (S101). One method to determine the mode, for example, includes setting a flag bit for determination on the adjustment map 22. Setting the initial value of the flag bit so as to move to the adjustment mode when the FW program is running allows the flag bit to move to the adjustment mode on startup for the first time. If it is determined that the optical transceiver is not in the adjustment mode (or adjustment has been completed) (NO) in step S101, the optical transceiver goes to a normal mode (S108).

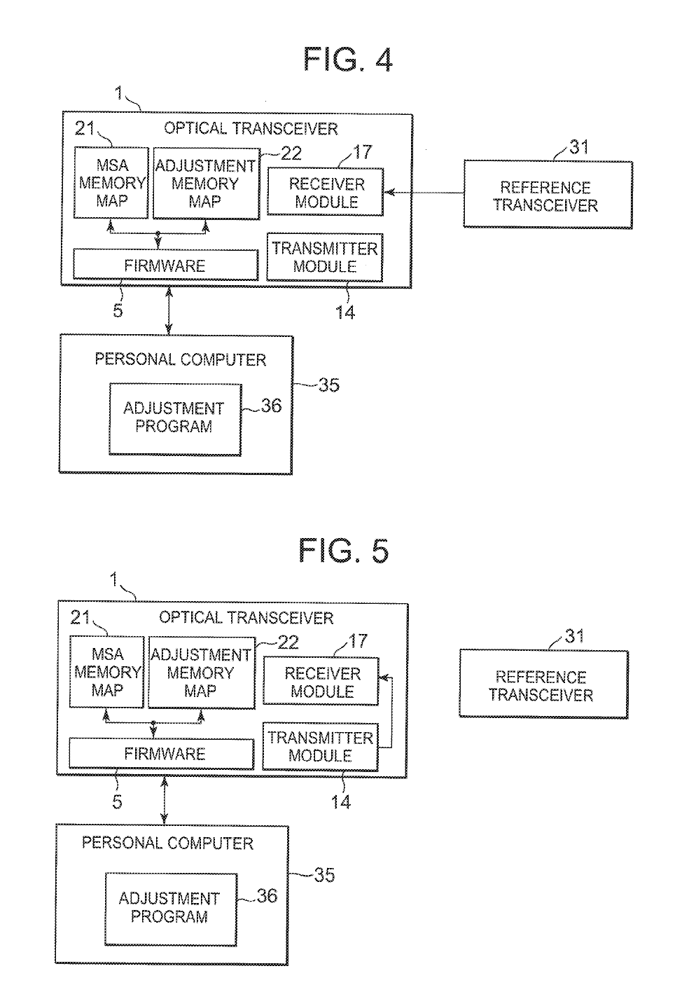

In step S101, if it is determined that the optical transceiver is in the adjustment mode (YES), the optical transceiver 1 enters a state of waiting for input of a reference signal (S102). FIG. 4 illustrates connection between the optical transceiver 1 and an external system in a state of waiting for the reference signal. At this moment, the optical transceiver 1 is connected, with a reference transceiver 31 and the personal computer 35. The reference transceiver 31 is connected with the receiver module 17 of the optical transceiver 1 to transmit a reference signal. The personal computer 35 includes an adjustment program 36 that is operatively associated with the firmware 5 of the optical transceiver 1 to contribute to execution of the adjustment processing.

When the reference signal is received via the receiver module 17 (YES) in step S102, information representing the characteristics, such as waveforms, of the reference signal is stored (S103). The processes of acquiring and storing the characteristics of the reference signal are performed by the firmware 5 of the optical transceiver 1. With these processes, the output power (REF_POW) and output amplitude (REF_AMP) of the reference signal are acquired in the form of a digital signal. The acquired characteristic information of the reference signal is stored in the adjustment memory map 22 as a target value of a transmitter signal.

Then, the optical transceiver 1 enters a state of waiting for a transmitter signal (S104). FIG. 5 illustrates connection between the optical transceiver 1 and the external system in a state of waiting for the transmitter signal. At this moment, the reference transceiver 31 is disconnected from the receiver module 17 of the optical module 1 and the transmitter module 14 is connected to the receiver module 17.

In step S104, if the transmitter signal is received via the receiver module 17 (YES), information representing the characteristics, such as waveforms, of the transmitter signal is stored. The processes of acquiring and storing the characteristics of the transmitter signal are performed by the firmware 5 of the optical transceiver 1. With these processes, the output power (OUT_POW) and output amplitude (OUT_AMP) of the transmitter signal are acquired in the form of a digital signal.

Then, the characteristic information of the transmitter signal is adjusted to be close to the REF_POW and REF_AMP stored in the adjustment memory map 22 as targets (S105). This adjustment can be made by the firmware 5 in the same procedures that are conventionally performed by an adjustment program.

The adjusted characteristic information of the transmitter signal is stored in the adjustment memory map 22 by the firmware 5, and the adjustment mode is terminated (S107). If a flag bit is used to determine the operation mode (S101) as described above, the termination processing of the adjustment mode is performed by setting the flag to a value that sends the optical transceiver into the normal mode. Upon startup of the optical transceiver 1 after termination of the adjustment processing, the optical transceiver is determined to be in the operation mode in the determination step (S101) and then performs normal operation.

According to the optical transceiver 1, adjustment of the transmitter signal can be made without external measurement apparatuses, such as a power meter and an optical waveform measuring device. In addition, adjustment of the transmitter signal can be made without making access from the external system, such as the personal computer 35, to the adjustment memory map 22. Accordingly, it is possible to widely use the adjustment program under varying measurement environments.

### Second Embodiment

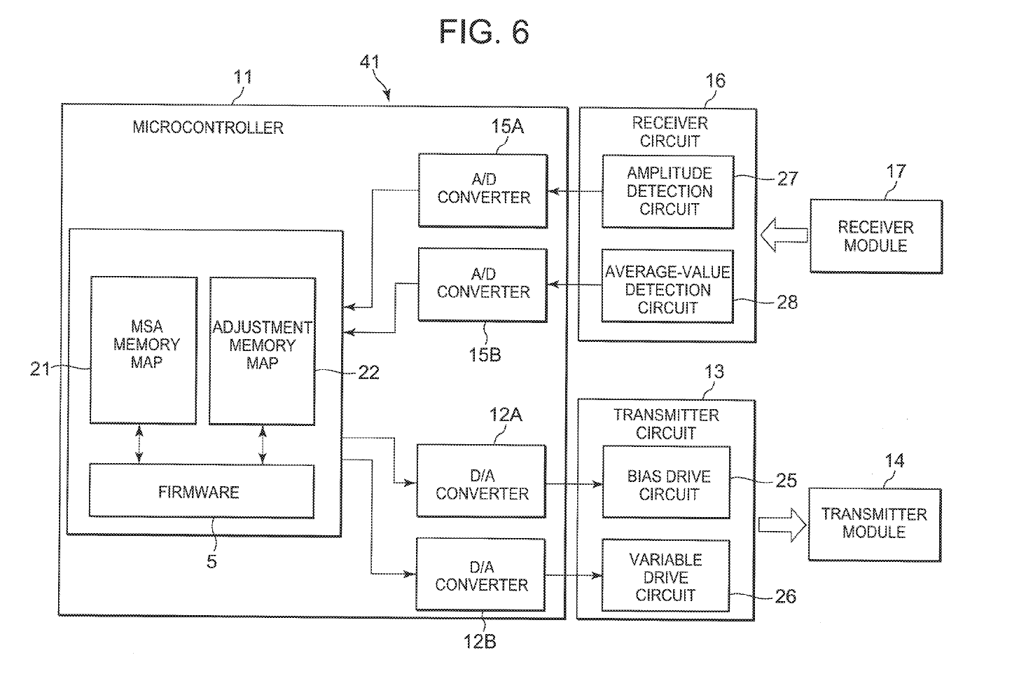

FIG. 6 illustrates the hardware configuration of an optical transceiver 41 according to the second exemplary embodiment. In the optical transceiver 41, the A/D converters 15A, 15B and D/A converters 12A, 12B are implemented as functions in the microcontroller 11.

### Third Embodiment

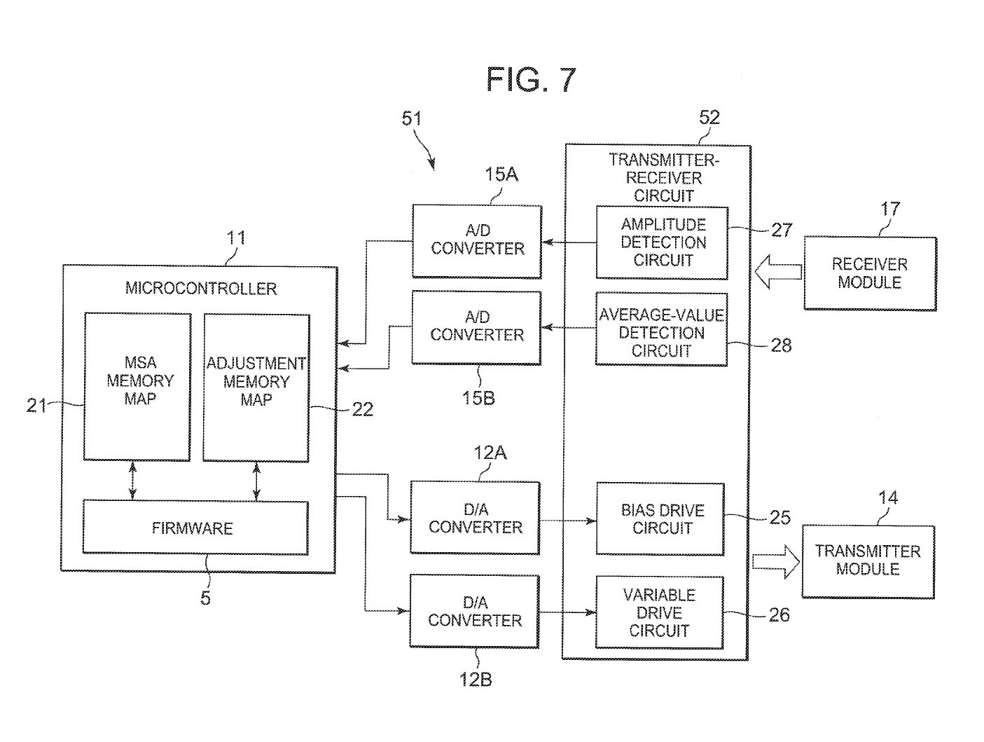

FIG. 7 illustrates the hardware configuration of an optical transceiver 51 according to the third exemplary embodiment. In the optical transceiver 51, functions 25, 26 on the transmitter side and functions 27, 28 on the receiver side are implemented as functions of a single transmitter-receiver circuit 52.

### Fourth Embodiment

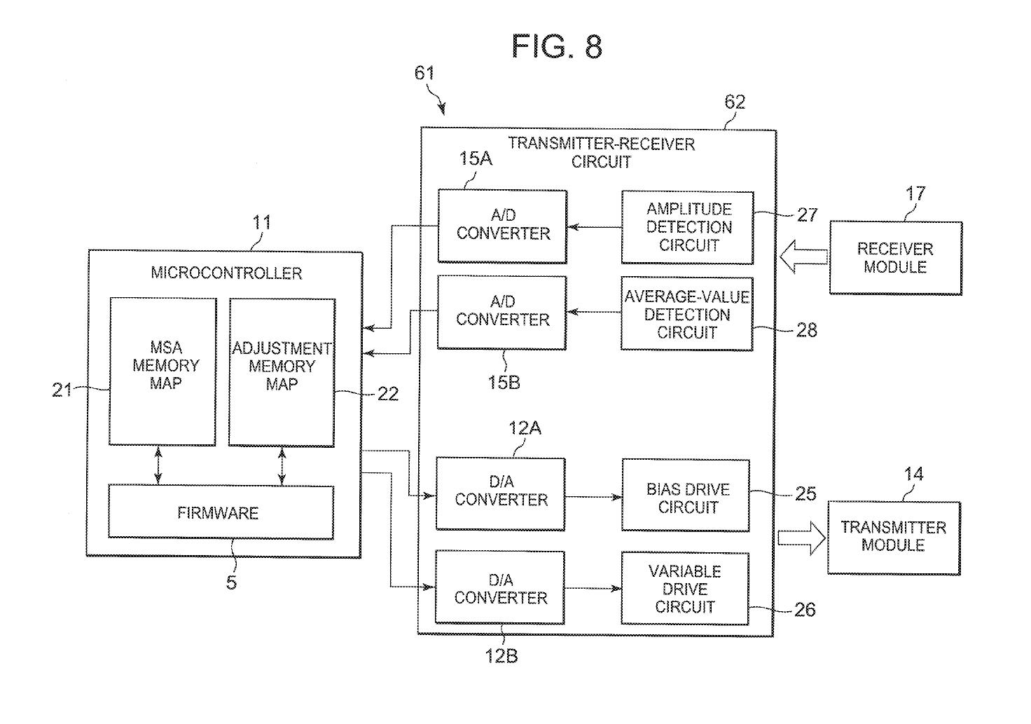

FIG. 8 illustrates the hardware configuration of an optical transceiver 61 according to the fourth exemplary embodiment. In the optical transceiver 61, the A/D converters 15A, 15B, the D/A converters 12A, 12B, and transmitter and receiver functions 25, 26, 27, 28 are implemented by a single transmitter-receiver circuit 62.

### Fifth Embodiment

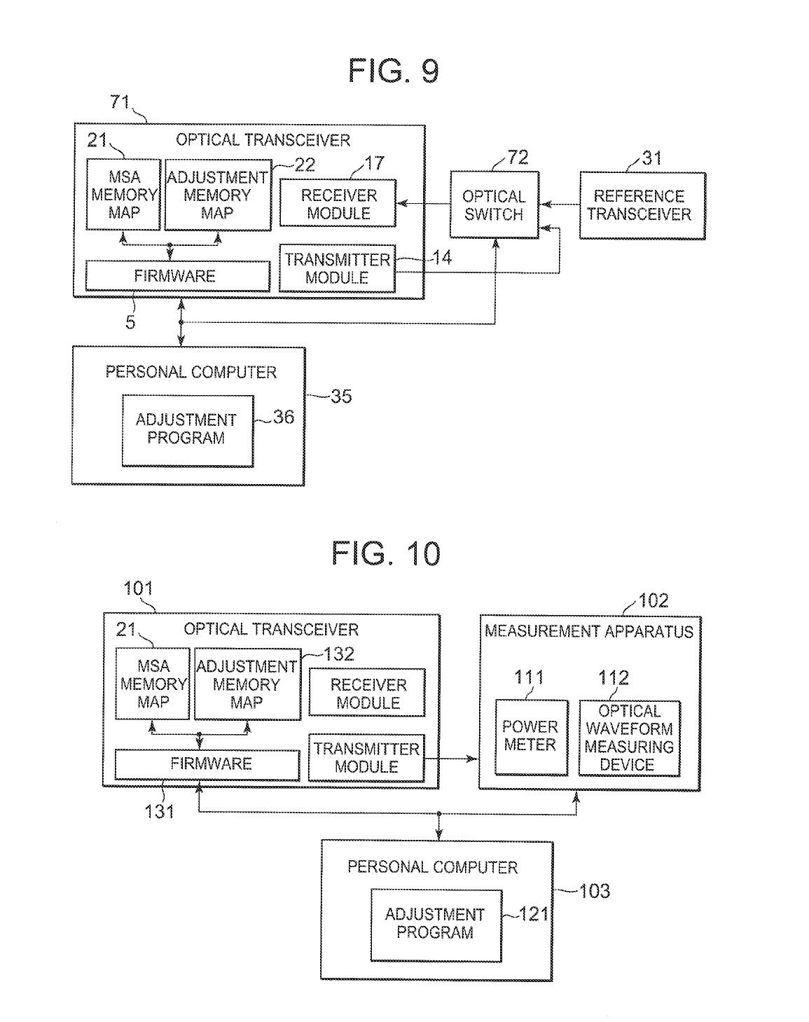

FIG. 9 illustrates connection between an optical transceiver 71 and an external system in a state of waiting for a reference signal according to the fifth exemplary embodiment. In the embodiment, an optical switch 72 is interposed between the optical transceiver 71 and a reference transceiver 31.

The optical switch 72 can switch between a reference signal from the reference transceiver 31 and a transmitter signal from the transmitter module 14 to send one of these to the receiver module 17. The switching is controlled by the adjustment program 36 on the personal computer 35. Specifically, the optical switch 72 is controlled to connect the reference transceiver 31 with the receiver module 17 in step S102 of the adjustment processing shown in FIG. 3 and to connect the transmitter module 14 with the receiver module 17 in step S104.

The configuration according to the second to fifth exemplary embodiments can also provide the same effects as the first exemplary embodiment.

It should be noted that the present invention is not limited to the above exemplary embodiments but modification can be made as needed without deviating from the spirit and scope the invention as defined by the claims.

### EXPLANATION OF REFERENCE NUMERALS

1, 41, 51, 61, 71 optical transceiver
2 transmission unit
3 reception unit
4 control unit
5 firmware
11 microcontroller
12A, 12B D/A converter
13 transmitter circuit
14 transmitter module
15A, 15B A/D converter
16 receiver circuit
17 receiver module
21 MSA memory map
22 adjustment memory map
25 bias drive circuit
26 variable drive circuit
27 amplitude detection circuit
28 average-value detection circuit
31 reference transceiver
35 personal computer
36 adjustment program
52, 62 transmitter-receiver circuit
72 optical switch

What is claimed is:

1. An optical transceiver comprising:
a transmitter that transmits an optical signal;
a receiver that receives a reference signal, wherein the receiver receives the optical signal transmitted by the transmitter; and
a controller that performs an adjustment of the optical signal transmitted by the transmitter based on the reference signal.

2. The optical transceiver according to claim 1, wherein the adjustment is performed so as to achieve a predetermined waveform of the optical signal.

3. The optical transceiver according claim 1, wherein the adjustment is performed by adjusting a characteristic of the optical signal based on a target value of the reference signal.

4. The optical transceiver according to claim 3, wherein the controller adjusts the characteristic of the optical signal to be substantially equal to the characteristic of the reference signal.

5. The optical transceiver according to claim 3, wherein the characteristic of the optical signal comprises at least one of:
an output amplitude of the optical signal; and
an optical output power of the optical signal.

6. The optical transceiver according to claim 3, further comprising a memory that stores information about the adjusted characteristic of the optical signal.

7. The optical transceiver according to claim 1, wherein the adjustment is performed when the optical transceiver is in an adjustment mode.

8. The optical transceiver according to claim 1, wherein the receiver receives the reference signal from outside the optical transceiver.

9. The optical transceiver according to claim 8, further comprising:
an optical switch connected with the receiver, and configured to receive the reference signal and an optical communication signal;
wherein:
when the optical switch is in a first mode, the reference signal is provided to the receiver via the optical switch; and
when the optical switch is in a second mode, the optical communication signal is provided to the receiver via the optical switch.

10. A method for controlling an optical transceiver, the method comprising:
transmitting an optical signal;
receiving a reference signal and the transmitted optical signal; and
adjusting the transmitted optical signal based on the reference signal.

11. A non-transitory computer readable medium embodying instructions for controlling a device to implement a control method for an optical transceiver, comprising:
transmitting an optical signal;
receiving a reference signal and the transmitted optical signal; and
adjusting the transmitted optical signal based on the reference signal.
